(19) United States
(12) Patent Application Publication
(10) Pub. No.: US 2013/0063149 A1
(43) Pub. Date: Mar. 14, 2013

(54) REDUCING FLUID CAPACITANCE AND CONDUCTANCE EFFECTS ON PIEZOELECTRIC RESONATOR MEASUREMENTS

(71) Applicants: Kerry L. SANDERLIN, Houston, TX (US); Sebastian CSUTAK, Houston, TX (US); Paul A. BERGREN, Houston, TX (US)

(72) Inventors: Peter W. REITTINGER, Katy, TX (US); Kerry L. SANDERLIN, Houston, TX (US); Sebastian CSUTAK, Houston, TX (US); Paul A. BERGREN, Houston, TX (US)

(73) Assignee: BAKER HUGHES INCORPORATED, Houston, TX (US)

(21) Appl. No.: 13/546,491

(22) Filed: Jul. 11, 2012

Related U.S. Application Data
(60) Provisional application No. 61/507,886, filed on Jul. 14, 2011.

(51) Int. Cl. G01V 3/20

(52) U.S. Cl. 324/324

(57) ABSTRACT

An apparatus for estimating a property of a fluid in a borehole penetrating the earth includes a piezoelectric material configured to be at least partially immersed in the fluid and embedded with a first electrode pair and a second electrode pair. An electronic unit is coupled to the first electrode pair and the second electrode pair and configured to measure motion impedance of the fluid caused by motion of the piezoelectric material by applying a first electrical stimulus to the first electrode pair and a second electrical stimulus to the second electrode pair and by receiving a first electrical signal from the first pair of electrodes and a second electrical signal from the second pair of electrodes to estimate the property. The resulting motion impedance measurement has a reduced influence from electrical properties of the fluid.

### CROSS REFERENCE TO RELATED APPLICATIONS

This application claims the benefit of an earlier filing date from U.S. Provisional Application Ser. No. 61/507,886 filed Jul. 14, 2011, the entire disclosure of which is incorporated herein by reference.

### BACKGROUND

1. Field of the Invention

The invention disclosed herein relates to sensors having a piezoelectric flexural mechanical resonator and, in particular, to these sensors being used in a downhole environment.

2. Description of the Related Art

A piezoelectric flexural mechanical resonator can be used in a sensor for measuring the density or viscosity of a fluid in contact with the resonator. Electrodes are used to create electric fields in a piezoelectric material, which in turn distorts (i.e., mechanically flexes) thereby displacing fluids around the material. As a result, the resonator resonates with one or more characteristics related to the density or viscosity of the fluid. The electrical impedance of the resonator (V_{IN}/I_{OUT}), or admittance (I_{OUT}/V_{IN}), can be measured as a function of frequency and interpreted as the density or viscosity of the fluid in contact with the resonator. Unfortunately, the electrical properties of this fluid, such as its dielectric constant and conductivity, influence the measurement of the resonator's impedance. When the electric fields stray into the fluid, they are influenced by the capacitance and conductance of the fluid. In this case, the transduction of the piezoelectric material becomes a function of the capacitance and conductance of the fluid surrounding the piezoelectric material and not the mechanical properties of the fluid itself. It would be well received in the drilling industry if the piezoelectric flexural mechanical resonator could be improved to account for electrical properties of fluids being sensed.

### BRIEF SUMMARY

Disclosed is an apparatus for estimating a property of a fluid in a borehole penetrating the earth. The apparatus includes a piezoelectric material configured to be at least partially immersed in the fluid and embedded with a first electrode pair and a second electrode pair. An electronic unit is coupled to the first electrode pair and the second electrode pair and configured to measure motion impedance of the fluid caused by motion of the piezoelectric material by applying a first electrical stimulus to the first electrode pair and a second electrical stimulus to the second electrode pair and by receiving a first electrical signal from the first pair of electrodes and a second electrical signal from the second pair of electrodes to estimate the property. The resulting motion impedance measurement has a reduced influence from electrical properties of the fluid.

Also disclosed is a method for estimating a property of a fluid in a borehole penetrating the earth, the method includes: disposing a piezoelectric material in the borehole, the piezoelectric material having embedded therein a first electrode pair having a first electrode and a second electrode and a second electrode pair having a third electrode and a fourth electrode; at least partially immersing the piezoelectric material in the fluid; applying a first electrical stimulus to the first electrode pair and a second electrical stimulus to the second electrode pair thereby causing motion of the fluid by the piezoelectric material; receiving a first electrical signal from the first electrode pair and a second signal from the second electrode pair; wherein the applying and receiving are performed by an electronic unit coupled to the first and second electrode pairs, the electronic unit being configured to measure motion impedance of the fluid using the first and second electrical signals in order to estimate the property and being further configured to reduce an electrical influence of the fluid on the motion impedance measurement.

A non-transitory computer-readable medium having computer-executable instructions for estimating a property of a fluid in a borehole penetrating the earth by implementing a method that includes: applying a first electrical stimulus to a first electrode pair embedded in piezoelectric material and a second electrical stimulus to a second electrode pair embedded in the piezoelectric material thereby causing motion of the fluid by the piezoelectric material, the piezoelectric material being at least partially disposed in the fluid; receiving a first electrical signal from the first electrode pair and a second signal from the second electrode pair; measuring motion impedance of the fluid using the first and second signals; and estimating the property using the motion impedance with a reduced electrical influence of the fluid on the motion impedance measurement.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a downhole tool having a piezoelectric flexural mechanical resonator sensor disposed in a borehole penetrating the earth;

FIG. 2 depicts aspects of the piezoelectric flexural mechanical resonator sensor having four electrodes;

FIG. 3 illustrates an equivalent circuit of a two-electrode resonator sensor disposed in a fluid having capacitance and conductance;

FIG. 4 depicts aspects of a simplified equivalent circuit of the two-electrode resonator sensor disposed in a fluid having capacitance and conductance;

FIG. 5 depicts aspects of a simplified equivalent circuit of two two-electrode resonator sensors represented as two-port network;

FIG. 6 depicts aspects of another configuration of the piezoelectric flexural mechanical resonator sensor having four electrodes; and

FIG. 7 presents one example of a method for estimating a property of a fluid downhole.

### DETAILED DESCRIPTION

A detailed description of one or more embodiments of the disclosed apparatus and method presented herein by way of exemplification and not limitation with reference to the Figures.

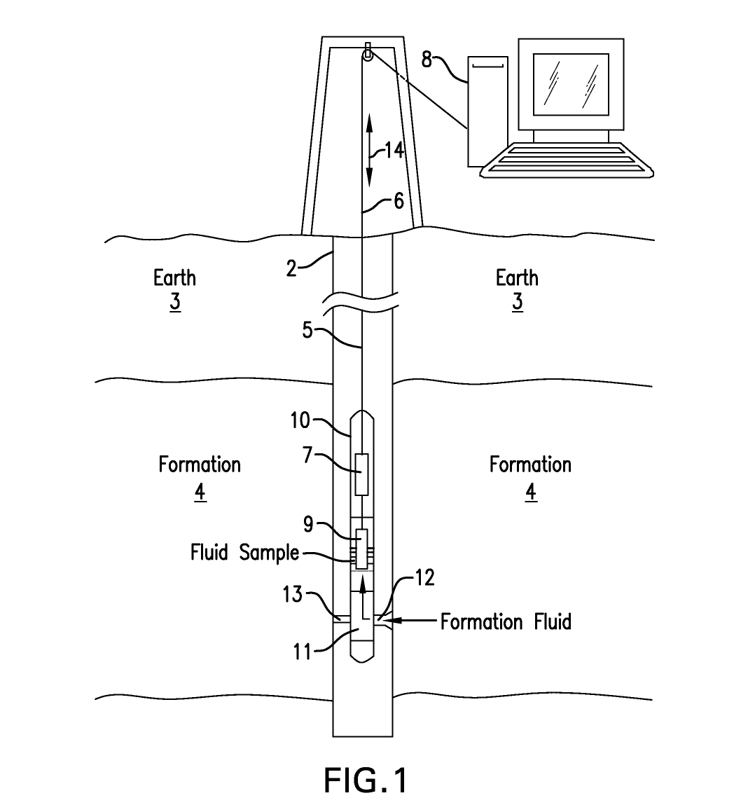

FIG. 1 illustrates an exemplary embodiment of a downhole tool 10 disposed in a borehole 2 penetrating the earth 3, which includes an earth formation 4. The formation 4 represents any subsurface material of interest such as a formation fluid. The downhole tool 10 is conveyed through the borehole 2 by a carrier 5. In the embodiment of FIG. 1, the carrier 5 is an armored wireline 6. Besides supporting the downhole tool 10 in the borehole 2, the wireline can also provide communications 14 between the downhole tool 10 and a computer processing system 8 disposed at the surface of the earth 3. Communications can include sending measurement data uphole to the system 8 or commands downhole to the tool 10. In logging-while-drilling (LWD) or measurement-while-drilling (MWD) embodiments, the carrier 5 can be a drill string. In order to operate the downhole tool 10 and/or provide a communications interface with the surface computer processing system 8, the downhole tool 10 includes downhole electronics 7.

Still referring to FIG. 1, the downhole tool 10 is configured to perform a measurement of a property of a fluid of interest downhole using a piezoelectric flexural mechanical resonator sensor 9 referred to as the piezoelectric resonator 9. The fluid of interest can be a formation fluid extracted from the formation 4 or a borehole fluid present in the borehole 2. In order to extract the formation fluid from the formation 4, the downhole tool 10 includes a formation fluid tester 11. The formation fluid tester 11 is configured to extend a probe 12 from the tester 11 to seal with a wall of the borehole 2. A brace 13 may be extended in order to keep the probe 12 in contact with the borehole wall. Pressure is then lowered in the probe 12 to cause a sample of the formation fluid to flow into the tester 11. Once the sample is extracted from the formation 4, the piezoelectric resonator 9 is immersed in the sample to perform a measurement of a property of the fluid sample. In another embodiment, a sample of a borehole fluid is extracted from the borehole 2 and the piezoelectric resonator 9 is immersed in that sample to measure a property of the borehole fluid.

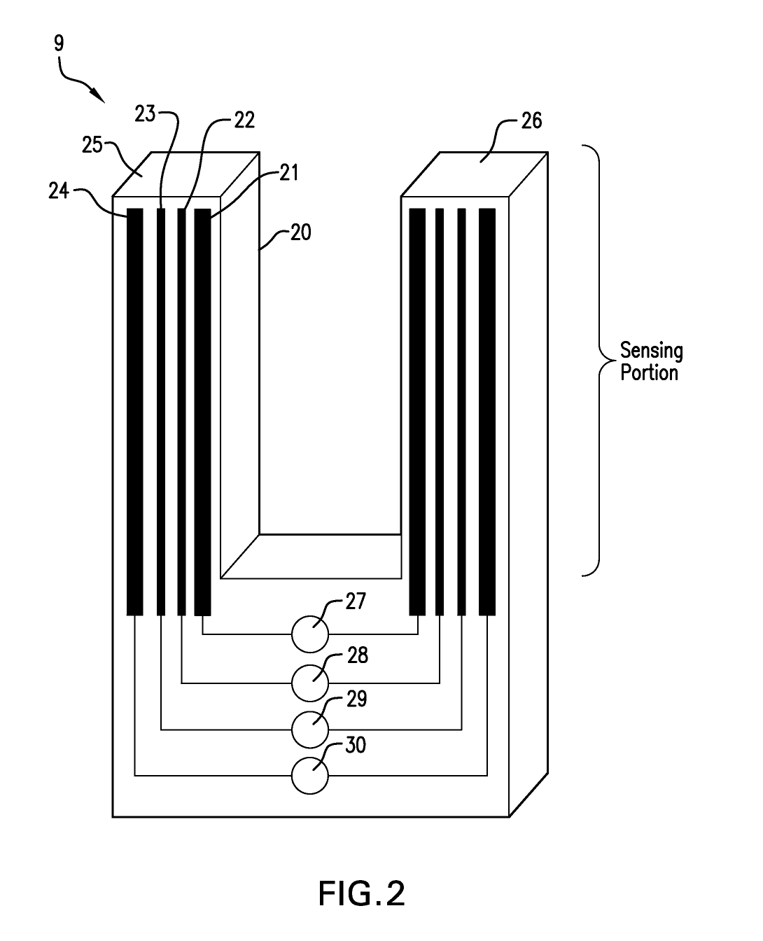

Reference may now be had to FIG. 2, which depicts aspects of the piezoelectric resonator 9. The piezoelectric resonator 9 includes a piezoelectric material 20, such as lithium niobate, embedded with a first electrode 21, a second electrode 22, a third electrode 23 and a fourth electrode 24. In one embodiment, the electrodes 21-24 are made of a gold foil. The piezoelectric material 20 has a shape configured to mechanically flex at a frequency in response to an electrical stimulus applied by at least two of the electrodes. In the embodiment of FIG. 2, the piezoelectric resonator 9 is shaped as a tuning fork having a first tine 25 and a second tine 26. The first tine 25 and the second tine 26 make up a sensing portion that is immersed in the fluid sample being tested. Because of the tuning fork configuration, portions of each of the electrodes 21-24 are disposed in each of the first tine 25 and the second tine 26 as shown in FIG. 2. The electrodes 21-24 have contact pads 27-30, respectively, through which electrical contact is made with the electrodes.

When a voltage with a sweeping frequency is applied to a pair of the electrodes, an electric field is created within the piezoelectric material 20 causing the piezoelectric resonator 9 to resonate or vibrate at a resonant frequency with an amplitude related to a property of the fluid in which the sensing portion is immersed. The resonating of the piezoelectric resonator 9 displaces or causes motion of the fluid in which it is immersed, thus, coupling the resonator 9 to that fluid. That is, the fluid experiences alternating displacements or motions as the piezoelectric resonator 9 resonates. During sensing of the property, a pair of electrodes presents an electrical impedance, referred to as a motion impedance, due to the resonating or vibrating. The motion impedance has a value related to a mechanical property, such as density or viscosity, of the fluid of interest. The resonant frequency is characterized by a peak or trough of an amplitude of a signal used to measure the impedance. While impedance measurements at the resonant frequency may present a signal with a higher signal to noise ratio, measurements can also be performed at other frequencies.

As noted above, when a voltage is applied to a pair of electrodes, an electric field is created between each of the electrodes in the set. This electric field can leak or stray from the piezoelectric material 20 into the fluid being tested and affect the impedance presented by the pair of electrodes. The accuracy of the measurements of the property can thus be affected by leakage of the electric fields. Factors affecting the amount of leakage of the electric fields are the dielectric constant and conductance of the fluid. The capacitance presented by the fluid is related to the dielectric constant of the fluid. The amount of inaccuracy due to the leakage of the electric fields is determined by the values of the dielectric constant and conductance.

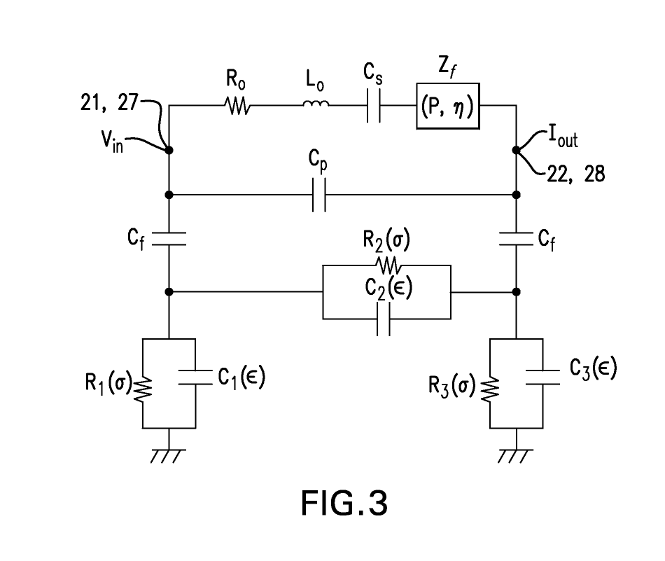

FIG. 3 illustrates an electrical equivalent circuit representing two electrodes embedded in a piezoelectric resonator immersed in the fluid being tested. For discussion purposes, the two electrodes can be the first electrode 21 and the second electrode 22. In this equivalent circuit, R_{O} represents the series resistance, C_{S} represents the series inductance, and C_{P} represents the parallel capacitance. All of these equivalent circuit elements are determined by the transducer (i.e., the piezoelectric resonator) and are independent of fluid properties. The motion impedance of the fluid, Z_{f}, is a function of only the fluid's density, ρ, and viscosity, η, thus, ρ and η can be determined from Z_{f}. C_{P} accounts for the electric field between the electrodes and confined to the piezoelectric material 20. The other equivalent circuit elements are related to the electrical properties of the fluid in which the piezoelectric resonator is immersed. C_{f} represents the capacitance of the piezoelectric material between the electrodes and the fluid. The electric fields in the surrounding fluid gives rise to stray resistances R1, R2, and R3 and stray capacitances C1, C2, and C3. Due to symmetry in one or more embodiments, R1 equals R3 and C1 equals C3. These stray equivalent circuit elements are functions of fluid conductivity, σ, and permittivity, ε. The permittivity is related to the dielectric constant of the fluid through a known relationship. In a downhole application where the conductivity and permittivity of a fluid of interest can vary widely and rapidly, these stray elements shunt current due to the stray electric fields around the transducer and reduce the accuracy the density and viscosity measurements. In some extreme cases, these effects can make the density and viscosity measurements impossible to perform.

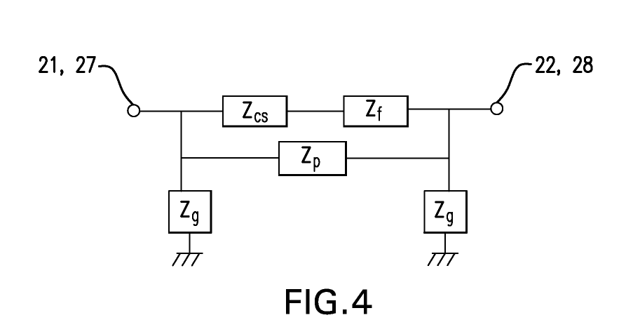

The electrical equivalent circuit illustrated in FIG. 3 can be simplified by combining certain equivalent circuit components and representing them as impedances (Z) as illustrated in FIG. 4.

In order to improve the accuracy of measurements of a property of the fluid being tested, the affects of the electric fields straying or leaking from the piezoelectric material 20 into the fluid being tested need to be taken into account. Disclosed is an approach using four electrodes embedded in the piezoelectric material 20. The four electrodes are represented as a two-port network where any two electrodes represent one port and the other two electrodes represent the other port. Leaking currents are taken into account by representing and solving for the leaking currents in an equivalent circuit in the two-port network. Hence, once the magnitudes of the leaking currents are known, their influence can be deleted from a measurement of a physical property (Z_{f}) of the fluid of interest.

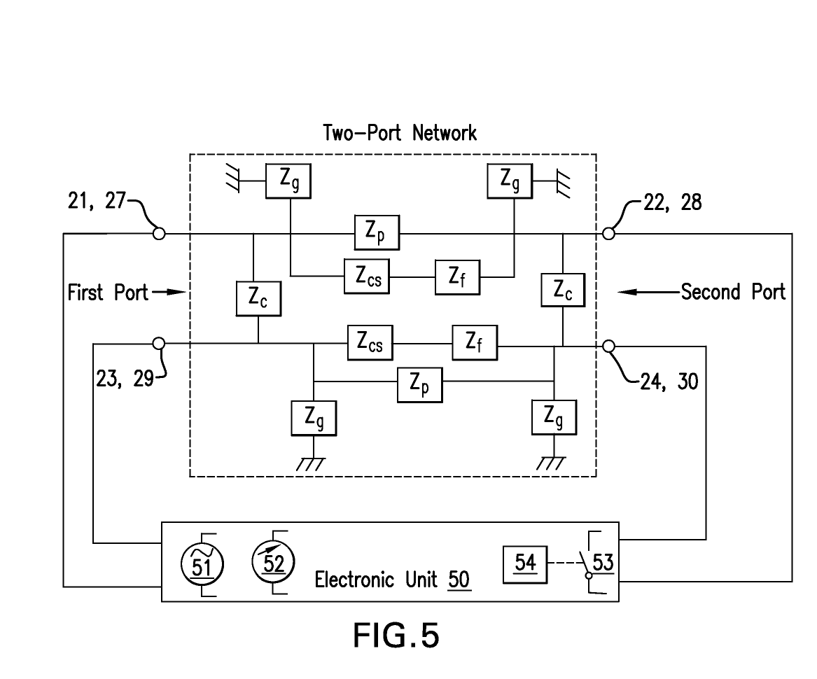

Reference may be had to FIG. 5, which depicts aspects of one example of an equivalent circuit configuration for performing a measurement of a physical property of the fluid of interest. In FIG. 5, the equivalent circuit representing a measurement performed using electrodes 21 and 22 is in parallel with the equivalent circuit representing a measurement performed using electrodes 23 and 24. Impedance Z_{C} represents both electrical and mechanical coupling between the upper circuit representing electrodes 21 and 22 and the lower circuit representing electrodes 23 and 24. The mechanical coupling from electrode motion in the upper or lower circuit influences electrode motion in the other circuit. Impedance Z_{CS} represents electrical impedance in series with the motion impedance Z_{f} while Z_{P} represents impedance parallel to the electrical and motion impedances. Impedance Z_{g} represents impedance to ground. It can be appreciated that the equivalent circuit shown in FIG. 5 can be represented as a two-port network where electrodes 21 and 23 represent a first port (or first pair of terminals) and electrodes 22 and 24 represent a second port (or second pair of terminals).

Determining the motion impedance Z_{f} involves determining the values of the various equivalent circuit impedances in an equivalent circuit such as the one shown in FIG. 5. Some of the circuit impedances represent current paths to ground and around the transducer. Hence, by determining the values of these impedances, the currents shunted to ground and around the transducer can be determined and compensated for in determining the motion impedance Z_{f} due to the mechanical properties of the fluid of interest. In one or more embodiments, all of the values of impedances in the equivalent circuit are determined. Hence, in addition to the mechanical properties of the fluid, the electrical properties of the fluid such as conductivity, σ, and permittivity, ε, can also be determined. Some of the values of impedances may be known before downhole measurements are performed by analysis, measurement or experimentation or some or all of the values can be determined by analysis such as by solving the equivalent circuit either by mesh-current analysis, node-voltage analysis or by treating the equivalent circuit as a multi-port network.

Using mesh-current analysis or node-voltage analysis, a set of independent linear equations can be written. These equations can also be written in matrix form. The set of equations is determinate if the number of equations equals the number of unknowns. The number of unknowns can be reduced by the aforementioned analysis or experimentation or by recognizing circuit symmetry. Populating values for the circuit elements in the equations or matrix is addressed below.

In treating the equivalent circuit as a multi-port network, where two unique terminals or electrodes are used to make up each port, the equivalent circuit is represented as connections of various elementary circuits. As discussed above, the equivalent circuit depicted in FIG. 5 can be treated as a two-port network. Complicated two port networks can be represented by five different types of connections of elementary two port circuits. There are five different types of two port connections: parallel-parallel; series-series; series-parallel; parallel-series; and cascaded. There are five different matrix forms and corresponding parameters populating these matrices for the correlation between the quantities of voltage and current at each of the ports. These parameters are called Y-parameters (admittance for the parallel-parallel connection), Z-parameters (impedance for the series-series connection), H-parameters (hybrid for the series-parallel connection), G-parameters (for the parallel-series connection), and A-parameters (chain parameters for the cascade connection). Matrices of these parameters in addition to S or scattering parameters and T or transfer scattering parameters are used to represent and solve for the impedance values in the two-port network. In that representing and solving a two-port network is known in the art of electrical engineering, no further detailed discussion of such is necessary.

Obtaining equivalent circuit impedance values for mesh-current or node-voltage analysis or treating the equivalent circuit as a multi-port network involves applying an electrical stimulus to one or more ports and measuring an electrical response at those ports or other ports not used for applying electrical stimuli. For example, using the equivalent circuit shown in FIG. 5 as an example, an electrical stimulus such as an alternating voltage can be applied to the first port and an electrical response such as current flowing in the first port can be measured. In addition, open circuit voltage and short circuit current can be measured at the second port. Further measurements can be performed iteratively or simultaneously. For example, an electrical stimulus can be applied to the second port and a response at the second port measured. In addition, open circuit voltage or short circuit current can also be measured at the first port. For simultaneous measurements, electrical stimulus applied to second port can be in quadrature to electrical stimulus applied to the first port. Data obtained from these measurements is used to populate the coefficients in the independent equations or in the matrices for the multi-port network analysis. An electronic unit 50 is configured to perform these types of measurements and can include various power (voltage or current) sources 51, voltage/current sensors 52, switches 53, and controllers 54. The power sources can have a fixed or variable output frequency. It can be appreciated that the electronic unit 50 can be incorporated into the downhole electronics 7 or the computer processing system 8.

The equivalent circuit can be generated by a processor in the downhole electronics 7, the surface computer processing system 8, or the electronic unit 50 or received by these processing systems if known beforehand.

It can be appreciated that the downhole tool 10 can include a flexural mechanical piezoelectric resonator sensor having more than two pairs of electrodes embedded in the piezoelectric material 20. In one or more embodiments using more than two pairs of electrodes, more than one two-port network or a multi-port network can be created and analyzed. The techniques disclosed above for providing accurate estimates of the mechanical properties and/or electrical properties of the fluid of interest are applicable to those configurations. It can be appreciated that using more than two pairs of electrodes and thus creating two or more two-port networks or a multi-port network can provide for multiple measurements of the motion impedance Z_{f} or the electrical properties of the fluid of interest. Multiple measurements of the same property can provide measurements that are less susceptible to noise (i.e., measurements having a higher signal to noise ratio).

It can be appreciated that when an equivalent circuit for two pairs of electrodes is developed and represented as a two-port network, any two terminals may be used as the first port with the remaining two terminals used as the second port. For example, in one embodiment with respect to FIG. 5, electrodes 21 and 22 can be used as the first port and electrodes 23 and 24 can be used as the second port. It can be further appreciated that the sensor 9 for any selected configuration may be calibrated by analysis, by testing the sensor 9 in a fluid having known mechanical and/or electrical properties (such as those discussed above), or by a combination of both methods.

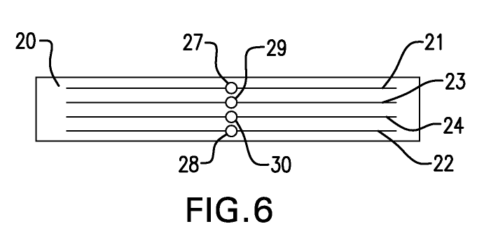

It can be appreciated that the piezoelectric material 20 and the electrodes 21-24 can assume shapes other than a tuning fork and that the electrodes can be disposed in any order in the piezoelectric material 20. FIG. 6 is one example of the piezoelectric material 20 and the electrodes 21-24 having a different shape and order of electrodes from the embodiment of FIG. 2.

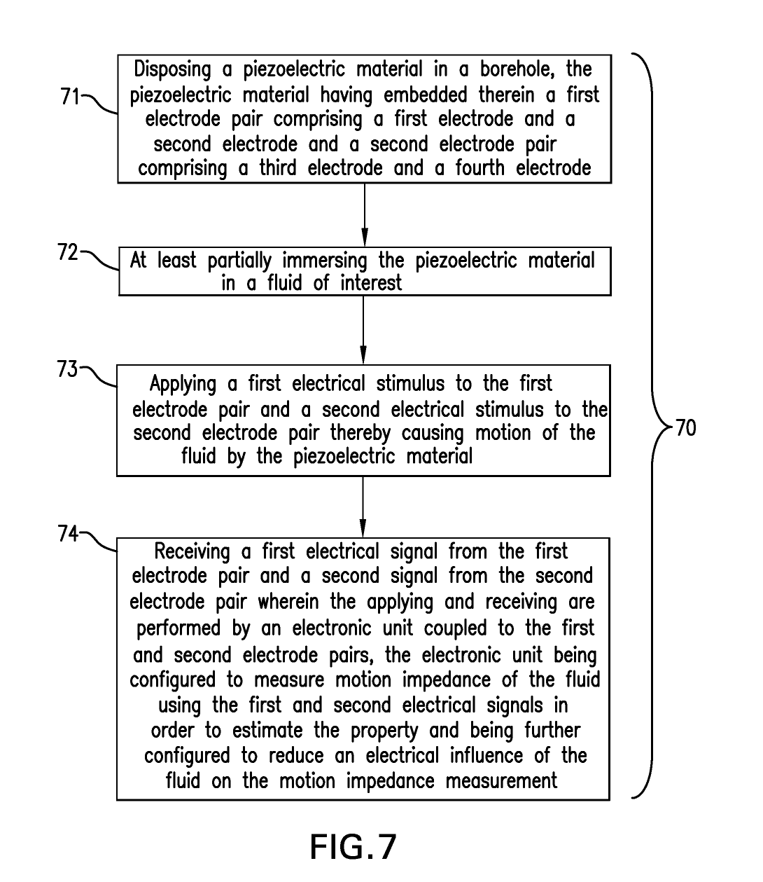

FIG. 7 presents one example of a method 70 for estimating a property of a fluid in a borehole penetrating the earth. The method 70 calls for (step 71) disposing a piezoelectric material in the borehole with the piezoelectric material having embedded therein a first electrode pair having a first electrode and a second electrode and a second electrode pair having a third electrode and a fourth electrode. Further, the method 70 calls for (step 72) at least partially immersing the piezoelectric material in the fluid. Further, the method 70 calls for (step 73) applying a first electrical stimulus to the first electrode pair and a second electrical stimulus to the second electrode pair thereby causing motion of the fluid by the piezoelectric material. Further, the method 70 calls for (step 74) receiving a first electrical signal from the first electrode pair and a second signal from the second electrode pair. The applying and receiving are performed by an electronic unit coupled to the first and second electrode pairs. The electronic unit is configured to measure motion impedance of the fluid using the first and second electrical signals in order to estimate the property and is further configured to reduce an electrical influence of the fluid on the motion impedance measurement.

In support of the teachings herein, various analysis components may be used, including a digital and/or an analog system. For example, the downhole electronics 7, the surface computer processing system 8, or the electronic unit 50 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors, switches and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second,” “third” and “fourth” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for estimating a property of a fluid in a borehole penetrating the earth, the apparatus comprising:
a piezoelectric material configured to be at least partially immersed in the fluid and embedded with a first electrode pair comprising a first electrode and a second electrode and a second electrode pair comprising a third electrode and a fourth electrode; and
an electronic unit coupled to the first electrode pair and the second electrode pair and configured to measure motion impedance of the fluid caused by motion of the piezoelectric material by applying a first electrical stimulus to the first electrode pair and a second electrical stimulus to the second electrode pair and by receiving a first electrical signal from the first pair of electrodes and a second electrical signal from the second pair of electrodes to estimate the property;
wherein the motion impedance measurement has a reduced influence from electrical properties of the fluid.

2. The apparatus according to claim 1, wherein the property is a mechanical property.

3. The apparatus according to claim 2, wherein the mechanical property is density or viscosity or a combination thereof.

4. The apparatus according to claim 1, wherein the apparatus is further configured to estimate an electrical property of the fluid.

5. The apparatus according to claim 1, wherein the electrical property of the fluid is conductivity, dielectric constant, permittivity, or some combination thereof.

6. The apparatus according to claim 5, wherein distances between adjacent electrodes are approximately equal.

7. The apparatus according to claim 1, wherein the electronic unit is further configured to apply the first electrical stimulus simultaneously with the second electrical stimulus.

8. The apparatus according to claim 7, wherein the electronic unit is further configured to apply the first electrical stimulus in quadrature with the second electrical stimulus.

9. The apparatus according to claim 1, wherein the electronic unit is further configured to apply the first electrical stimulus and the second electrical stimulus sequentially.

10. The apparatus according to claim 1, wherein the electronic unit is further configured to receive or generate an equivalent circuit representing the first and second pair of electrodes embedded in the piezoelectric material, the equivalent circuit comprising a first motion impedance between the first and third electrodes and a second motion impedance between the second and fourth electrodes.

11. The apparatus according to claim 10, wherein the electronic unit is further configured to receive a third electrical signal from the second electrode pair responsive to the first electrical stimulus applied to the first electrode pair and a fourth electrical signal from the first electrode pair responsive to the second electrical stimulus applied to the second electrode pair, the first and second electrical stimuli and the first, second, third and fourth electrical signals being used to determine impedances in the equivalent circuit.

12. The apparatus according to claim 10, wherein the equivalent circuit further comprises an impedance representing an electrical property of the fluid.

13. The apparatus according to claim 1, wherein the piezoelectric material is disposed at a carrier configured to be conveyed through the borehole.

14. The apparatus according to claim 13, wherein the carrier comprises a wireline or a drill string.

15. A method for estimating a property of a fluid in a borehole penetrating the earth, the method comprising:
disposing a piezoelectric material in the borehole, the piezoelectric material having embedded therein a first electrode pair comprising a first electrode and a second electrode and a second electrode pair comprising a third electrode and a fourth electrode;
at least partially immersing the piezoelectric material in the fluid;
applying a first electrical stimulus to the first electrode pair and a second electrical stimulus to the second electrode pair thereby causing motion of the fluid by the piezoelectric material;
receiving a first electrical signal from the first electrode pair and a second signal from the second electrode pair;
wherein the applying and receiving are performed by an electronic unit coupled to the first and second electrode pairs, the electronic unit being configured to measure motion impedance of the fluid using the first and second electrical signals in order to estimate the property and being further configured to reduce an electrical influence of the fluid on the motion impedance measurement.

16. The method according to claim 15, wherein the motion impedance is used to estimate density and/or viscosity of the fluid.

17. The method according to claim 15, further comprising the electronic unit receiving or generating an equivalent circuit representing the first and second electrode pairs embedded in the piezoelectric material, the equivalent circuit comprising a first motion impedance between the first and third electrodes and a second motion impedance between the second and fourth electrodes.

18. The method according to claim 17, further comprising receiving a third electrical signal from the second electrode pair responsive to the first electrical stimulus applied to the first electrode pair and a fourth electrical signal from the first electrode pair responsive to the second electrical stimulus applied to the second electrode pair, the first and second electrical stimuli and the first, second, third and fourth electrical signals being used to determine impedances in the equivalent circuit.

19. The method according to claim 18, wherein values of impedances in the equivalent circuit representing electrical properties of the fluid are used to determine a conductivity and/or dielectric constant of the fluid.

20. A non-transitory computer-readable medium comprising computer-executable instructions for estimating a property of a fluid in a borehole penetrating the earth by implementing a method comprising:
applying a first electrical stimulus to a first electrode pair embedded in piezoelectric material and a second electrical stimulus to a second electrode pair embedded in the piezoelectric material thereby causing motion of the fluid by the piezoelectric material, the piezoelectric material being at least partially disposed in the fluid;
receiving a first electrical signal from the first electrode pair and a second signal from the second electrode pair;
measuring motion impedance of the fluid using the first and second signals; and
estimating the property using the motion impedance with a reduced electrical influence of the fluid on the motion impedance measurement.
